(19) United States
(12) Patent Application Publication
(10) Pub. No.: US 2013/0286439 A1
(43) Pub. Date: Oct. 31, 2013

(54) PRINTER AND PRINTING METHOD

(71) Applicant: MIMAKI ENGINEERING CO., LTD., Tomi-city (JP)

(72) Inventor: Masaru OHNISHI, Tomi-city (JP)

(21) Appl. No.: 13/868,115

(22) Filed: Apr. 23, 2013

(30) Foreign Application Priority Data
Apr. 27, 2012 (JP) 2012-104183

(51) Int. Cl. G06K 15/02

(52) U.S. Cl. CPC G06K 15/1878
USPC 358/2.1

(57) ABSTRACT

A printer for printing using at least three types of colors includes one or more heads ejecting at least two inks including first and second inks for printing one of the three types of colors. The first ink includes a first coloring material having a first density. The second ink includes a second coloring material different from the first coloring material and has a second density which is higher than the first density.

This application claims the benefit of Japanese Application No. 2012-104183, filed on Apr. 27, 2012 in Japan, which is hereby incorporated by reference as if fully set forth herein.

### BACKGROUND

1. Field of the Disclosure

The present disclosure relates to a printer and a printing method.

2. Discussion of the Related Art

Japanese Patent laid-open No. 62-279954 discloses a method of forming a mixed color section including yellow by adhering a yellow recording liquid prior to recording liquid in other color. However, the chromaticity plotted in a color space in L*a*b* coordinates for a coloring material representing a color such as magenta often forms a curve. A chromaticity curve in the color space indicates that the color tone changes as its density changes.

### SUMMARY

Accordingly, the present disclosure is directed to a printer and a printing method that substantially obviates one or more problems due to limitations and disadvantages of the related art.

The present disclosure provides a printer and a printing method for reducing color tone changes due to density changes. A printer that prints using at least three types of colors according to a preferred embodiment of the present disclosure includes one or more heads ejecting at least two inks including first and second inks including different coloring materials, respectively. The densities of the coloring materials are different. As such, compared to using only one ink, by using of a combination of two inks, it is possible to control the color tone changes due to density changes.

A printer according to another preferred embodiment of the present disclosure prints using at least three types of colors. The printer includes one or more heads ejecting at least two inks including first and second inks for printing one of the three colors. The first ink includes a first coloring material having a first density. The second ink includes a second coloring material which is different from the first coloring material and has a second density which is higher than the first density. A chromaticity curve or straight line plotted in a color space in L*a*b* coordinates for the first coloring material is located inside of a chromaticity curve plotted in the color space for the second coloring material having the higher density.

When two inks are used such that the chromaticity curve or straight line plotted in the color space for the first coloring material having the lower density is located inside of the chromaticity curve plotted for the second coloring material having the higher density, a resultant chromaticity curve, which is plotted when a combination of the coloring materials is used, is closer to a straight line. In other words, the resultant chromaticity curve has a smaller curvature.

A linear chromaticity curve means that there is a less color tone change. Thus, color tone changes due to density changes can be reduced by having a linear chromaticity curve. The three types of colors used by the printer are preferably yellow, cyan, and magenta, and one of the three colors for which the at least two inks are used is preferably magenta.

Generally, a chromaticity line for a coloring material representing magenta plotted in a color space in the L*a*b* coordinates is usually a curve. The color tone change of the coloring material due to its density change can be reduced by making the curve more linear.

The three types of colors used by the printer are preferably yellow, cyan, and magenta, and one of the three colors for which the at least two inks are used is preferably magenta. The different coloring materials included in the first and second inks are preferably CAS No. 980-27-6 and CAS No. 3089-17-6. A resultant chromaticity curve of the first and second coloring materials is a linear curve. Therefore, there is a less color tone change due to a chromaticity or density change.

A printing method according to another preferred embodiment includes ejecting, by one or more heads, at least two inks comprising first and second inks for printing one of three types of colors. The first ink includes a first coloring material having a first density. The second ink includes a second coloring material being different from the first coloring material and having a second density which is higher than the first density of the first coloring material. As such, compared to using only one ink, by using of a combination of two inks, it is possible to control the color tone changes due to density changes.

A printing method according to another preferred embodiment of the present disclosure prints using at least three types of colors. The method includes ejecting, by one or more heads, at least two inks including first and second inks for printing one of the three colors. The first ink includes a first coloring material having a first density. The second ink includes a second coloring material which is different from the first coloring material and has a second density which is higher than the first density. A chromaticity curve or straight line plotted in a color space in L*a*b* coordinates for the first coloring material is located inside of a chromaticity curve plotted in the color space for the second coloring material having the higher density.

When two inks are used such that the chromaticity curve or straight line plotted in the color space for the first coloring material having the lower density is located inside of the chromaticity curve plotted for the second coloring material having the higher density, a resultant chromaticity curve, which is plotted when a combination of the coloring materials is used, is closer to a straight line. In other words, the resultant chromaticity curve has a smaller curvature. A linear chromaticity curve means that there is a less color tone change. Thus, color tone changes due to density changes can be reduced by having a linear chromaticity curve.

A printer for printing using at least three types of colors according to another embodiment includes one or more heads ejecting at least two inks comprising first and second inks for printing one of the three types of colors. The first ink includes a first coloring material having a first density. The second ink includes a second coloring material being different from the first coloring material and having a second density which is higher than the first density of the first coloring material. Preferably, the first and second coloring materials are selected such that three conditions are satisfied. In a first condition, a distance between a resultant chromaticity curve and a chromaticity curve plotted in a color space in L*a*b* coordinates for the second coloring material and plotted to an extent that the second ink is ejected more than the first ink is less than a distance between the resultant chromaticity curve and a chromaticity curve plotted in the color space for the first coloring material. In a second condition, that a distance between the resultant chromaticity curve and a chromaticity curve plotted in the color space for the first coloring material and plotted to an extent that the first ink is ejected more than the second ink is less than a distance between the resultant chromaticity curve and the a chromaticity curve plotted in the color space for the second coloring material. Finally, in a third condition, the resultant chromaticity curve passes through an origin of the color space.

A resultant chromaticity curve, which is plotted when a combination of the coloring materials is used, is much closer to a straight line. In other words, there is a less color tone change of a mixed color represented by two coloring materials. Therefore, the color tone change due to the density change can be effectively controlled.

An advantageous effect of the preferred embodiments described above is that a color tone change due to a density change is greatly reduced.

Additional advantages, objects, and features may be set forth in part in the description which follows and in part will become apparent to those having ordinary skill in the art upon examination of the following or may be learned from practice of the disclosure. The objectives and other advantages of the disclosure may be realized and attained by the structure particularly pointed out in the written description and claims hereof as well as the appended drawings.

It is to be understood that both the foregoing general description and the following detailed description of the disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate embodiment(s) of the disclosure and together with the description serve to explain the principle of the disclosure. In the drawings;

FIG. 1 illustrates chromaticity curves of coloring materials shown in a color space in L*a*b* coordinates.

### DETAILED DESCRIPTION OF THE DISCLOSURE

Reference will now be made in detail to the preferred embodiments of the disclosure, examples of which are illustrated in the accompanying drawings. Wherever possible, the same reference numbers will be used throughout the drawings to refer to the same or like parts.

A printer for printing using at least three types of colors according to an embodiment of the present disclosure includes one or more heads ejecting at least two inks comprising first and second inks for printing one of the three types of colors. The first ink includes a first coloring material having a first density. The second ink includes a second coloring material which is different from the first coloring material and has a second density which is higher than the first density. In other words, two coloring materials are selected such that a resultant chromaticity curve plotted in a color space in L*a*b* coordinates for the coloring materials is close to a straight line.

In other words, two coloring materials are selected such that the resultant chromaticity curve is a linear curve that extends from an origin of the color space to a point of a chromaticity curve of one coloring material which is furthest from the origin of the color space. Thus, a color tone change due to a density change is greatly reduced when a combination of two different coloring materials is used instead of using only one coloring material.

“Inside” of a chromaticity curve means inside of a curve formed by an entire portion of the chromaticity curve. When the chromaticity curve does not form a single curve such as an S-shape curve, “inside” of the chromaticity curve means inside of an approximate curve estimated for each curve.

A printer according to another preferred embodiment of the present disclosure prints using at least three types of colors. The printer includes one or more heads ejecting at least two inks including first and second inks for printing one of the three colors. The first ink includes a first coloring material having a first density. The second ink includes a second coloring material which is different from the first coloring material and has a second density which is higher than the first density. A chromaticity curve or straight line plotted in a color space in L*a*b* coordinates for the first coloring material is located inside of a chromaticity curve plotted in the color space for the second coloring material having the higher density.

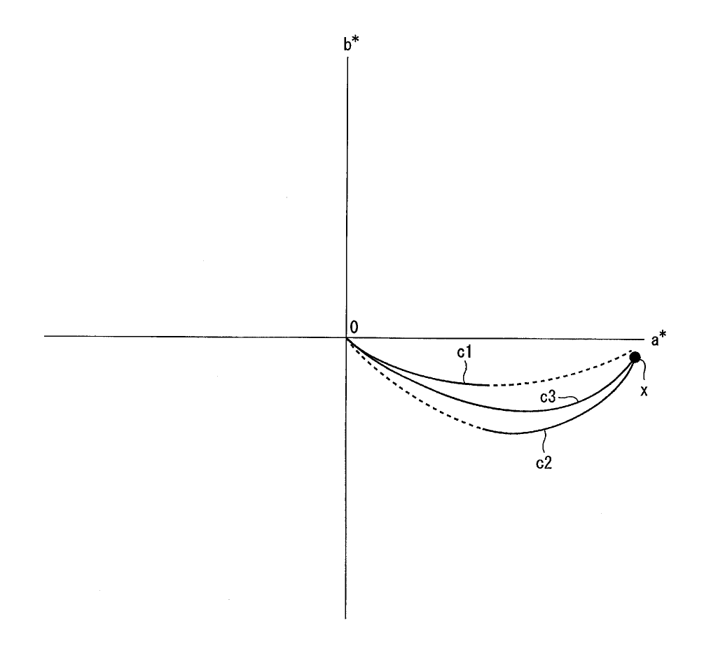

The first and second coloring materials are selected such that a chromaticity curve or straight line plotted in the color space for the first coloring material having the lower density is located inside of a chromaticity curve for the second coloring material. When such coloring materials are used, a resultant chromaticity curve is a linear curve. The resultant chromaticity curve extends from an origin of the color space to a point of the chromaticity curve for the second coloring material (point x shown in FIG. 1) which is furthest from the origin. The linear resultant chromaticity curve means a less color tone change. Therefore, the color tone change due to the density is reduced. Thus, the use of a combination of two coloring materials having high and low densities, rather than the use of the coloring materials having high densities only (not low densities) when printing all mixed colors, can reduce the color tone change due to the density change. In such a case, a chromaticity curve or straight line for the coloring material having a low density is located between a resultant chromaticity curve and a chromaticity curve of the coloring material having a high density.

Although a color space in L*a*b* coordinates indicates a relationship between L*, a*, and b*, the chromaticity characteristics plotted in a*b coordinates shown in the present disclosure apply to all Ls. The scope of the present disclosure applies when L* is at least 50 and the above condition is satisfied. Thus, the color space in L*a*b* coordinates is CIE1976L*a*b*.

FIG. 1 illustrates chromaticity curves of coloring materials shown in a color space in L*a*b* coordinates. It shows the advantageous effect of the present disclosure. FIG. 1 shows a color space where L is fixed (e.g. L=50)

Chromaticity curve c2 plotted in the color space shown in FIG. 1 for a coloring material having a higher density (hereinafter referred to as “second coloring material”) has a high curvature. In order to reduce the color tone change due to density change, an ideal resultant chromaticity curve should extend from point x, which is a highest point of a portion of c2 that corresponds to a higher density, to an origin (point o shown in FIG. 1) of the color space.

A coloring material having chromaticity curve c1 plotted in the color space shown in FIG. 1 for a coloring material having a lower density (hereinafter referred to as “first coloring material”) can be used and its density should be lower than the density of the second coloring material.

The density of the second coloring material is higher than the density of the first coloring material having chromaticity curve c1. A solid line portion of chromaticity curve c1 corresponds to a chromaticity curve plotted to the extent that the first coloring material is used and a solid line portion of chromaticity curve c2 corresponds to a chromaticity curve plotted to the extent that the second coloring material is used.

During the actual printing process, a resultant chromaticity curve (c3 shown in FIG. 1) is a combination of c1 and c2 because the two types of the coloring materials are repeatedly printed according to color brightness. Resultant chromaticity curve c3 is closer to the ideal resultant chromaticity curve than c2. Thus, the color tone change due to density change can be reduced when expressing light and shade of the actual color.

Among other colors, the preferred types of colors used by the printer and the printing method are yellow, cyan, and magenta when coloring materials having a higher density and a lower density are used. And preferably, the color for which the two coloring materials are used is magenta.

Generally, a chromaticity curve for a coloring material representing magenta plotted in a color space in the L*a*b* coordinates usually has a greater curvature than coloring materials representing other colors. The color tone change of the coloring material due to its density change can be reduced by making the curve more linear. When expressing magenta by two types of coloring materials according to the present disclosure, it is preferred that the two types of coloring materials are CAS No. 980-26-7 and CAS No. 3089-17-6. According to the present disclosure, a coloring material with a higher density is CAS No. 980-26-7 and a coloring material with a lower density is CAS No. 3089-17-6.

Also, according to the present disclosure, it is preferred that a color for which the two types of coloring materials are used is cyan. The chromaticity lines of coloring materials expressing cyan plotted in a color space in L*a*b* coordinates are usually curves. The color tone change due to density change can be reduced by making the curves more linear during the actual printing process. To express cyan by using two types of coloring materials according to the present disclosure, the preferred coloring materials can be phthalocyanine blue and cobalt blue. A resultant chromaticity curve combining chromaticity curves of the two types of the coloring materials is a linear curve. Thus, there is a less color tone change due to the density change.

According to another embodiment of the present disclosure, a printer includes one or more heads ejecting at least two inks including first and second inks for printing one of at least three types of colors. The first ink includes a first coloring material having a first density. The second ink includes a second coloring material different from the first coloring material, and has a second density higher than the first density. The first and second coloring materials are selected such that three conditions are satisfied. In a first condition, a distance between a straight line portion of a resultant chromaticity curve and a chromaticity curve plotted in a color space in L*a*b* coordinates for the second coloring material and plotted to an extent that the second ink is ejected more than the first ink is less than a distance between the resultant chromaticity curve and a chromaticity curve plotted in the color space for the first coloring material. In a second condition, that a distance between the resultant chromaticity curve and a chromaticity curve plotted in the color space for the first coloring material and plotted to an extent that the first ink is ejected more than the second ink is less than a distance between the resultant chromaticity curve and the a chromaticity curve plotted in the color space for the second coloring material. Finally, in a third condition, the resultant chromaticity curve passes through an origin of the color space.

In other words, to the extent that the first coloring material is used more than the second coloring material, the chromaticity curve of the first coloring material is closer to the resultant chromaticity curve. And, to the extent that the second coloring material is used more, the chromaticity curve of the second coloring material is closer to the resultant chromaticity curve.

The resultant chromaticity curve combining chromaticity curves of the first and second coloring materials is a linear curve. This means there is a less color tone change for mixed colors printed using the first and second coloring materials. Therefore, the color change due to density change can be reduced. The conditions are satisfied when the coloring material having the higher density is CAS No. 980-26-7 and the coloring material having the lower density is CAS No. 3089-17-6.

Configurations and structures of the printer according to the preferred embodiments are not limited but it preferably includes one or more heads ejecting at least two inks, and a controller controlling operation of the heads based on image information representing images to be printed. It is preferred to have as many heads as necessary to store the inks. It is also preferred that a number of heads is at least equal to a number of types of inks.

A printing method according to another embodiment includes ejecting, by one or more heads, at least two inks including first and second inks for printing one of three types of colors. The first ink includes a first coloring material having a first density. The second ink includes a second coloring material which is different from the first coloring material and has a second density which is higher than the first density. A chromaticity curve or straight line plotted in a color space in L*a*b* coordinates for the first coloring material is located inside of a chromaticity curve plotted in the color space for the second coloring material having the higher density. The printing method can be applied to, but not limited to, conventional inkjet printers.

When expressing light and shade of a color or a mixed color, it is preferred to use two types of inks including different coloring materials. For example, two coloring materials for expressing magenta are selected such that a chromaticity line or curve plotted in a color space in the L*a*b* coordinates for a coloring material having the lower density is inside of a chromaticity curve for a coloring material having the higher density. When the two coloring materials are included in separate inks, respectively, the light and shade of magenta are expressed by combining the inks. Therefore, a contrast of light and shade of a color is enhanced because the color tone change due to density change is reduced.

In addition, a granularity can be reduced by using two different types of coloring materials having high and low densities instead of using only same types of coloring materials with various densities to express light and shade of a color. For example, when expressing light and shade of a color or a mixed color by using two inks including same coloring materials with different densities, if the coloring material with a lower density is used, granularity resulted from particles of pigments is likely to occur. However, according to the present disclosure, such granularity can be reduced.

The printers and the printing methods described above can be applied to, but not limited to, conventional inkjet printers or any other image printing apparatuses.

It will be apparent to those skilled in the art that various modifications and variations can be made in the disclosure without departing from the spirit or scope of the disclosures. Thus, it is intended that the disclosure covers the modifications and variations of this disclosure provided they come within the scope of the appended claims and their equivalents.

What is claimed is:

1. A printer for printing using at least three types of colors, the printer comprising:
one or more heads ejecting at least two inks comprising first and second inks for printing one of the at least three types of colors, the first ink including a first coloring material having a first density, the second ink including a second coloring material being different from the first coloring material and having a second density which is higher than the first density.

2. The printer of claim 1, wherein the at least three types of colors are yellow, cyan, and magenta and the one of the at least three types of colors is magenta.

3. The printer of claim 2, wherein the first and second coloring materials are CAS No. 980-26-7 and CAS No. 3089-17-6.

4. The printer of claim 1, wherein a chromaticity curve or straight line plotted in a color space in L*a*b* coordinates for the first coloring material is located inside of a chromaticity curve drawn in the color space for second coloring material having the second density which is higher than the first density.

5. The printer of claim 4, wherein the at least three types of colors are yellow, cyan, and magenta and the one of the at least three types of colors is magenta.

6. The printer of claim 5, wherein the first and second coloring materials are CAS No. 980-26-7 and CAS No. 3089-17-6.

7. A printing method for printing using at least three types of colors, the method comprising:
ejecting, by one or more heads, at least two inks comprising first and second inks for printing one of the at least three types of colors, the first ink including a first coloring material having a first density, the second ink including a second coloring material different from the first coloring material and having a second density which is higher than the first density.

8. The printing method of claim 7, wherein a chromaticity curve or straight line plotted in a color space in L*a*b* coordinates for the first coloring material is located inside of a chromaticity curve plotted in the color space for the second coloring material having the second density which is higher than the first density.

9. A printer for printing using at least three colors, the printer comprising:
one or more heads ejecting at least two inks comprising first and second inks for printing one of the at least three types of colors, the first ink including a first coloring material having a first density, the second ink including a second coloring material being different from the first coloring material and having a second density which is higher than the first density,
wherein the coloring materials are selected such that a distance between a resultant chromaticity curve and a chromaticity curve plotted in a color space in L*a*b* coordinates for the second coloring material and plotted to an extent that the second ink is ejected more than the first ink is less than a distance between the resultant chromaticity curve and a chromaticity curve plotted in the color space for the first coloring material,
wherein the coloring materials are selected such that a distance between the resultant chromaticity curve and a chromaticity curve plotted in the color space for the first coloring material and plotted to an extent that the first ink is ejected more than the second ink is less than a distance between the resultant chromaticity curve and the a chromaticity curve plotted in the color space for the second coloring material,
wherein the coloring materials are selected such that the resultant chromaticity curve passes through an origin of the color space.
